(19) United States
(12) Patent Application Publication
(10) Pub. No.: US 2005/0197945 A1
(43) Pub. Date: Sep. 8, 2005

(54) Optical banking card

(75) Inventor: W. Jack Harper, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 11/051,544

(22) Filed: Feb. 4, 2005

Related U.S. Application Data
(60) Provisional application No. 60/544,469, filed on Feb. 12, 2004.

(51) Int. Cl. G06F 17/60

(52) U.S. Cl. 705/35; 705/42; 705/43

(57) ABSTRACT

Methods are provided for executing a banking transaction for a customer. Account information is read from an optical banking card for a banking account associated with the optical banking card. The account information includes a current balance for the banking account. A request is received from the customer to execute the banking transaction, which effects a change in the balance of the account. A movement of funds is coordinated in accordance with the request to execute the banking transaction. Updated account information is written to the optical banking card. The updated account information includes a new current balance for the banking account that accounts for the movement of funds.

### CROSS REFERENCE TO RELATED APPLICATION

This application is a nonprovisional of, and claims the benefit of the filing date of U.S. Prov. Pat. Appl. No. 60/544,469, entitled “OPTICAL BANKING CARD,” filed Feb. 12, 2004 by W. Jack Harper, the entire disclosure of which is incorporated herein by reference for all purposes.

### BACKGROUND OF THE INVENTION

This application relates generally to optical cards. More specifically, this application relates to the use of optical cards for banking applications.

There is a significant portion of the population of many countries that does not participate effectively with banking systems. Such groups are commonly described as the “unbanked” or “underbanked.” In the United States, for example, some estimate that the size of the underbanked population is as large as 50,000,000 people, more than one sixth of its population. In developing countries, the existence of underbanked populations is even more acute, with access to bank accounts and credit being available only for the wealthiest classes. In part, exclusion of some from access to banking services may be driven by requirements of minimum balances, high periodic fees, social and historical factors, and the like.

Financial activities of the underbanked population typically revolve around various limited individual financial products and services that take the place of more traditional banking practices, and in some cases are limited to cash-only transactions. These financial services include such services as check-cashing, payday-lending, money-transfer, money-order, and similar services. These types of services are used by the underbanked in lieu of a more traditional arrangement where an employee has his pay deposited semimonthly into a checking account at a bank, from which funds may be withdrawn as cash, on which checks may be written to pay bills or forward funds to relatives, and the like. Instead, an underbanked person may receive a check from his employer periodically, which he converts to cash at a check-cashing service, using the received cash to purchase money orders to pay bills, etc.

This arrangement may have significant disadvantages for the underbanked person in the form of relatively high charges for each of the individual services, a lack of convenience, less diversity of services, increased susceptibility to personal crime due to carrying cash, and others. There is accordingly a general need in the art for alternative mechanisms to provide individuals with access to banking services.

### BRIEF SUMMARY OF THE INVENTION

Embodiments of the invention thus allow the execution of banking transactions using optical cards. The optical cards may be used in a network that is interconnected only through optical cards, which may profoundly lower the cost of banking, particularly in countries with limited or expensive. The optical cards may also be used in a network that additionally has some internal electronic interconnection and/or external connections to other networks.

In some embodiments, a method is provided for executing a banking transaction for a customer. Account information is read from an optical banking card for a banking account associated with the optical banking card. The account information includes a current balance for the banking account. A request is received from the customer to execute the banking transaction, which effects a change in the balance of the account. A movement of funds is coordinated in accordance with the request to execute the banking transaction. Updated account information is written to the optical banking card. The updated account information includes a new current balance for the banking account that accounts for the movement of funds.

In some instances, coordinating the movement of funds may comprise receiving funds for allocation to the bank account by augmenting the current balance. For example, cash may be received from the customer, with the new current balance being equal to the current balance plus a value of the cash, in which case the banking transaction corresponds to a deposit to the banking account. In another embodiment, an electronic confirmation, either online or by optical card, may be received that finds have been provided by a third party, with the new current balance being equal to the current balance plus a value of the funds provided by the third party, in which case the banking transaction corresponds to a funds transfer from the third party to the banking account. A payroll distribution may be implemented by receiving electronic confirmation of funds provided by an employer of the customer as wages, with the new current balance being equal to the current balance plus a value of the wages. In one embodiment, a negotiated instrument such as a check or money order may be cashed by receiving the negotiated instrument from the customer, with the new balance being equal to the current balance plus a value of the negotiated instrument. In determining “value” in these various embodiments, some accommodation may be made to account for service fees, currency conversions, and the like.

In other instances, coordinating the movement of funds may comprise providing funds allocated from the banking account by reducing the current balance. For example, a withdrawal from the banking account may be implemented by providing cash to the customer, with the new current balance being equal to the current balance less a value of the cash. A debit purchase transaction may be implemented by providing funds electronically to a merchant entity for goods or services purchased by the customer, with the new current balance being equal to the current balance less a payment value for the goods or services. Similarly, a bill-payment transaction may be implemented by providing funds equal to a payment amount set forth in a bill issued by an issuer to the customer, with the new current balance being equal to the current balance less the payment amount. In one embodiment funds are provided electronically to a third party, with the new current balance being equal to the current balance less a value of the funds provided to the third party, thereby implement a funds transfer from the banking account to the third party. As before, determination of “value” in these various embodiments may accommodate service fees, currency conversions, and the like.

In some embodiments, identification information of an authorized holder of the optical banking card may additionally be read from the optical banking card. That the customer is the authorized holder may be verified from the identification information. For example, the identification may comprise an optically encoded photograph of the authorized holder, or may comprise an optically encoded record of a biometric feature of the authorized holder.

Such banking transactions may be executed using an optical banking card that comprises a laminated card having a pattern of burn holes that encode information according to a set of fields. An identification field has optically encoded information identifying a feature of an authorized holder of the optical banking card. An account-summary field has optically encoded information summarizing a status of a banking account associated with the optical banking card. A transaction-history field has optically encoded information providing particulars of banking transactions executed with the optical banking card. In one embodiment, the transaction-history field may provide particulars for every banking transaction executed with the optical banking card.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-1C are illustrations of different embodiments of optical banking cards;

FIGS. 2A-2G are schematic illustrations of different embodiments of banking architectures that make use of the optical cards of FIGS. 1A-1C;

FIG. 3 is a diagram providing an exemplary data structure for banking information maintained on an optical card; and

FIGS. 4A-4H are flow diagrams illustrating different types of transactions that may be performed using the optical cards of FIGS. 1A-1C with the architectures of FIGS. 2A-2G.

### DETAILED DESCRIPTION OF THE INVENTION

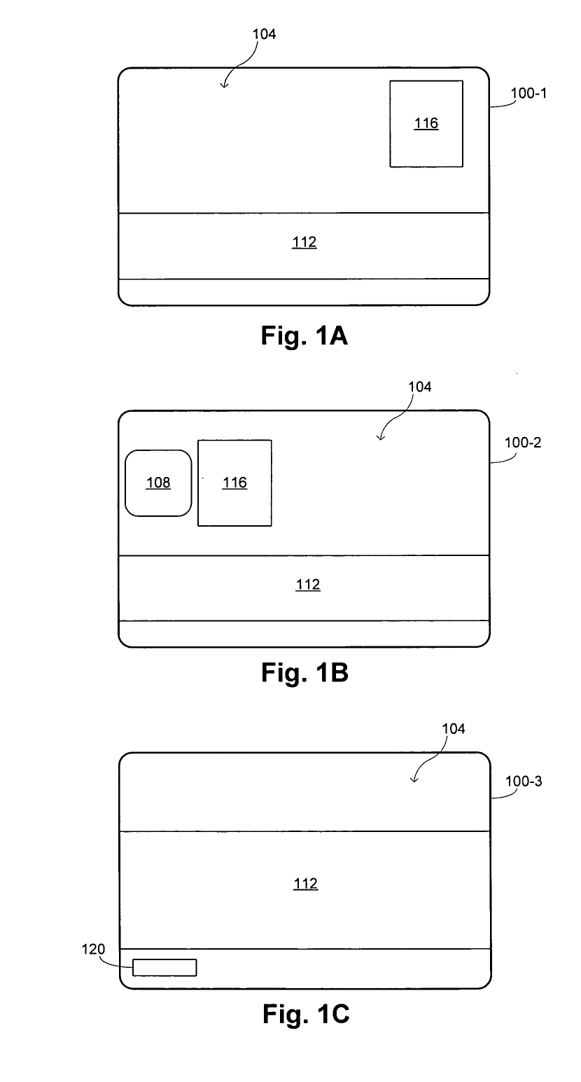

Embodiments of the invention provide methods and systems that allow banking services to be provided and/or mediated through optical-card records. Such embodiments may function well with a variety of optical-card designs, some of which are illustrated in FIGS. 1A-1C. Such optical cards may be of the specific type described in U.S. Pat. No. 5,979,772, entitled “OPTICAL CARD” by Jiro Takei et al., the entire disclosure of which is incorporated herein by reference for all purposes, but more generally include any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 100-1000 times the amount of information as a typical smart card. Unlike smart cards, optical cards are also impervious to electromagnetic fields, including static electricity, and they are not damaged by normal bending and flexing.

These properties of optical cards, particularly their large storage capacity, makes it possible for complete banking-transaction records to be stored, in addition to diverse identification information. For example, a single optical card may store fingerprint biometrics for all ten fingers, iris biometrics for both eyes, hand-geometry specifications for both hands, and a high-resolution color photograph of a cardholder while still using far less than 1% of its capacity. The large storage capacity also allows information for essentially every transaction that involves the card to be written to the card and thereby provide a permanent detailed audit trail of the card's use.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser burns a small hole, about 2 μm in diameter, in the material; the hole can be sensed by a low-power laser during a read cycle. The presence or absence of the burn spot defines a binary state that is used to encode data. In some embodiments, the data can be encoded in a linear x-y format described in detail in the ISO/IEC 11693 and 11694 standards, the entire contents of which are incorporated herein by reference for all purposes.

FIG. 1A provides a diagram that illustrates a structure for an optical card in one embodiment. The card 100-1 includes a cardholder photograph 116, an optical storage area 112, and a printed area 104 on one side of the card. The other side of the card could include other features, such as a bar code(s) or other optically recognizable code, a signature block, a magnetic stripe, counterfeiting safeguards, and the like. Embodiments in which the optical card includes a magnetic stripe may usefully provide compatability with older legacy online banking networks. The printed area 104 could include any type of information, such as information identifying the cardholder so that, in combination with the photograph 116, it acts as a useful aid in authenticating a cardholder's identity. The printed area 104 could also include information identifying the issuer of the card, and the like. The optical storage area 112 holds digitized information, and may comprise a plurality of individual sections that may be designated individually by an addressing system.

The information on optical cards is generally visible to readers, and may in some instances be encrypted to prevent unauthorized access. A description of encryption and other security techniques that may be used with the optical cards is provided in copending, commonly assigned U.S. Pat. Appl. No. 60/543,595, entitled “CRYPTOGRAPHICALLY SECURE TRANSACTIONS WITH OPTICAL CARDS,” filed Feb. 10, 2004 by Jack Harper, the entire disclosure of which is incorporated herein by reference for all purposes. Information on the optical banking card 100 may also sometimes be authenticated. Authenticated information can be verified as being unmodified by any number of parties in a trust chain. By using certificates, the authenticity of the stored information can be confirmed by a number of parties. Various techniques using a variety of different algorithms known to those of skill in the art may be used to confirm authenticity. In some cases, the authenticity of an optical card may be confirmed from a wide-area network, but in other cases authenticity can be confirmed without contacting other parties.

An example of use of such a chain of trust is a mechanism that covers a situation where biometrics are to be used but are not obtainable for a particular cardholder when the card is issued. It is known that for certain biometric measurements, there is often a small but finite segment of the population from which biometric measurements cannot be obtained. In such an embodiment, a local manager may be authenticated to the issuing machine with his/her biometrics on his/her optical card, and the biometric requirement overridden. The override event is then recorded both on the cardholder's card and on the local manager's card.

Another embodiment of an optical banking card 100-2 is illustrated in FIG. 1B. This embodiment adds electronics 108 to the optical card 100-2 to provide smart-card capabilities. The electronics 108 may be interfaced with contacts on the surface of the card 100-2. The electronics could include a microprocessor, nonvolatile memory, volatile memory, a cryptographic processor, a random-number generator, and/or any other electronic circuits. Unlike the optical storage area 112, information stored in the electronics 108 is not discernible without destroying the card 100-2. Electronic security measures could be used to protect reading information stored in the electronics 108.

A further embodiment of an optical banking card 100-3 is shown in FIG. 1C. To illustrate that different embodiments may accommodate different sizes of optical storage areas, this embodiment uses a larger optical storage area 112 than the embodiments of FIG. 1A or 1B. In addition, a radio-frequency identification (“RFID”) tag 120 that can be read by proximity readers may be included.

The optical banking cards illustrated in FIGS. 1A-1C may be used in a variety of different network structures, some of which do not require large, complex support systems. For example, in some network structures, a plurality of transaction processing units (“TPUs”) are interconnected solely by optical cards. In such cases, transaction information is stored only on the optical cards carried by cardholders, rather than being stored in any central or local database. Software and other informational updates to the TPUs may be communicated with optical cards containing information for those purposes. A detailed description of a TPU that may be used in embodiments of the invention is provided in commonly assigned U.S. Pat. No. 6,775,774, entitled “OPTICAL CARD BASED SYSTEM FOR INDIVIDUALIZED TRACKING AND RECORD KEEPING,” filed Dec. 6, 1999 by Jack Harper, the entire disclosure of which is incorporated herein by reference for all purposes. Generally, the TPU may include a card slot adapted to accept an optical card so that data may be read from or written to the optical card, a display screen for displaying data about the optical card or transaction being executed, and a printer for generating hard copy.

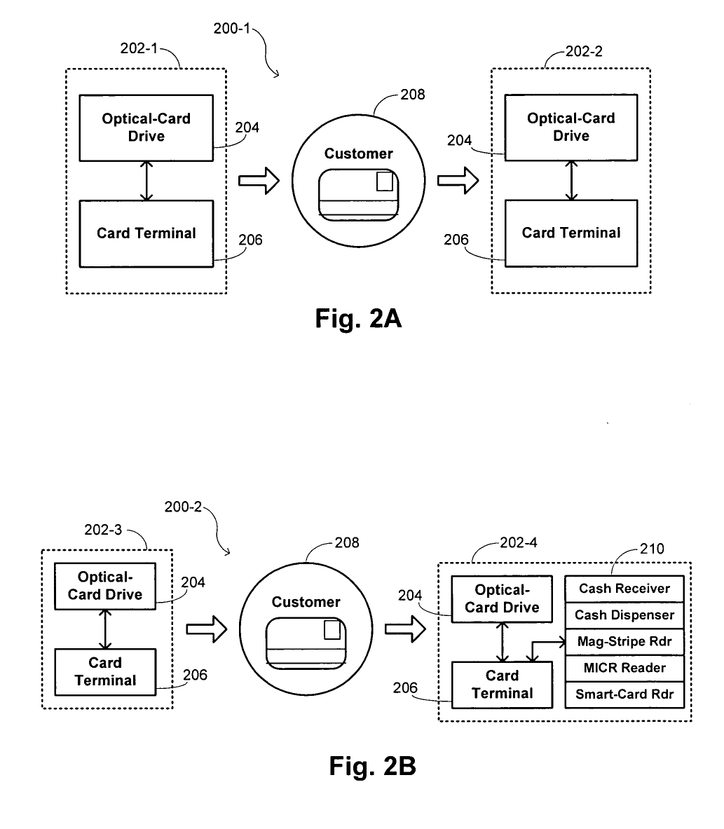

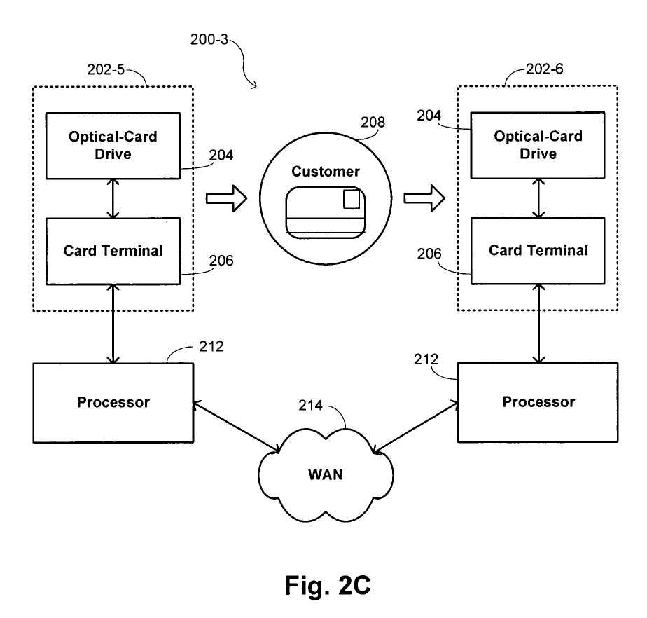

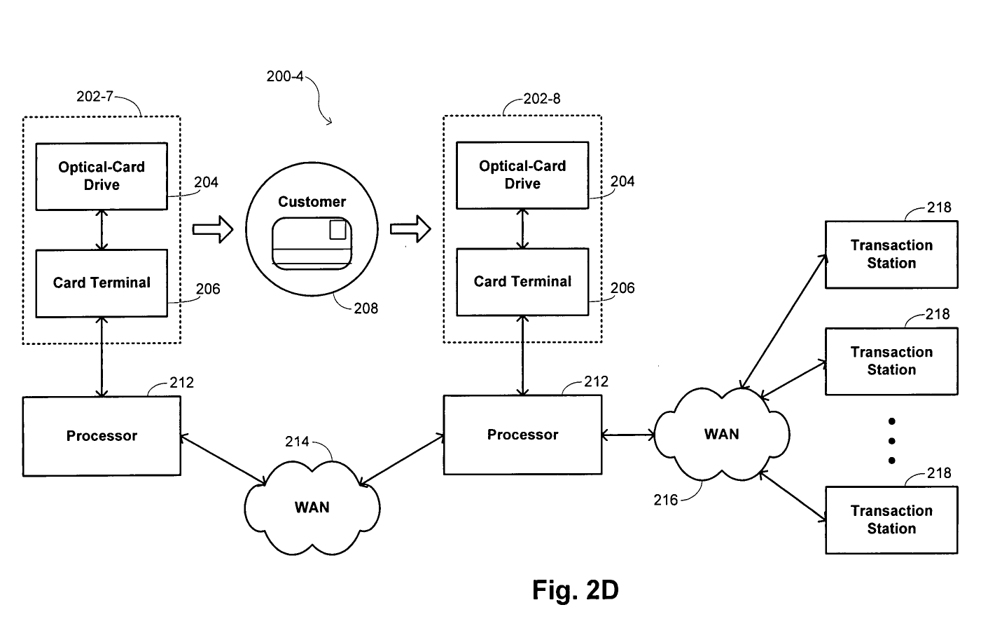

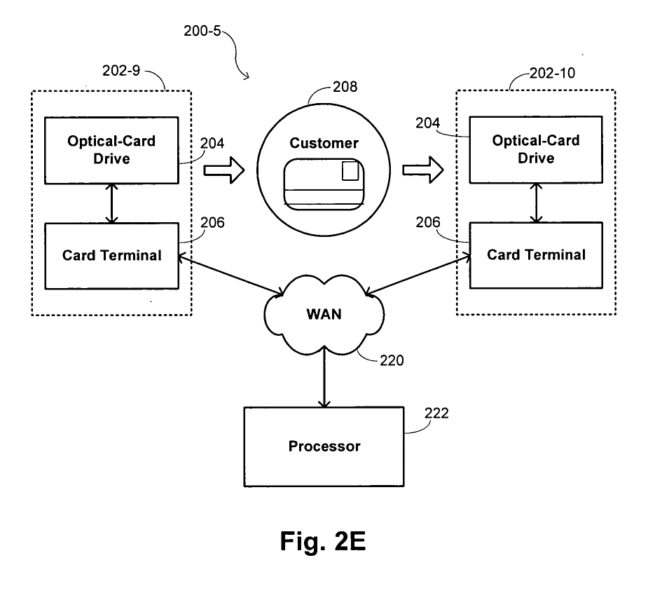

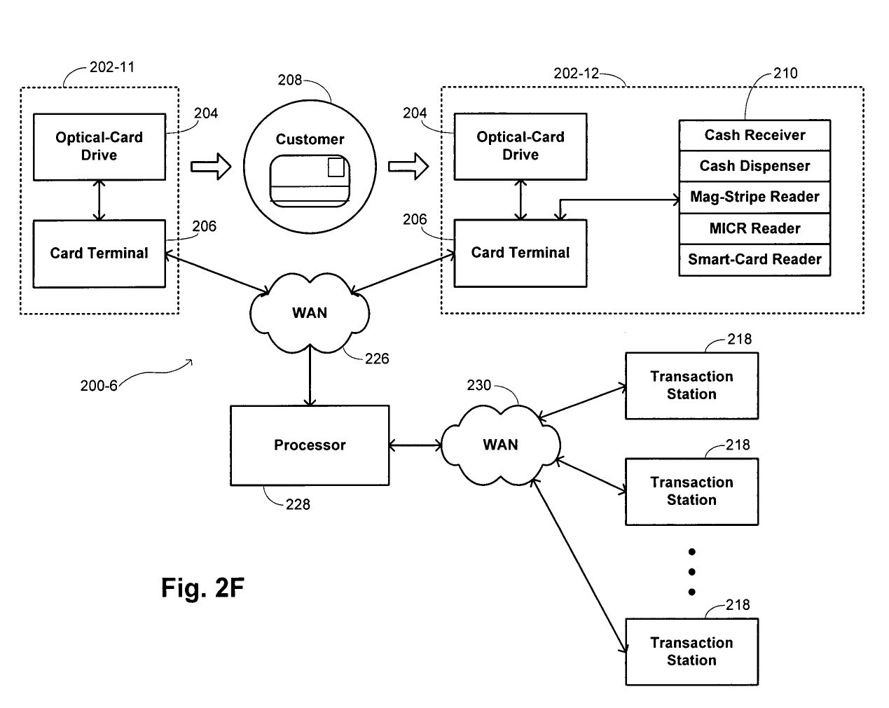

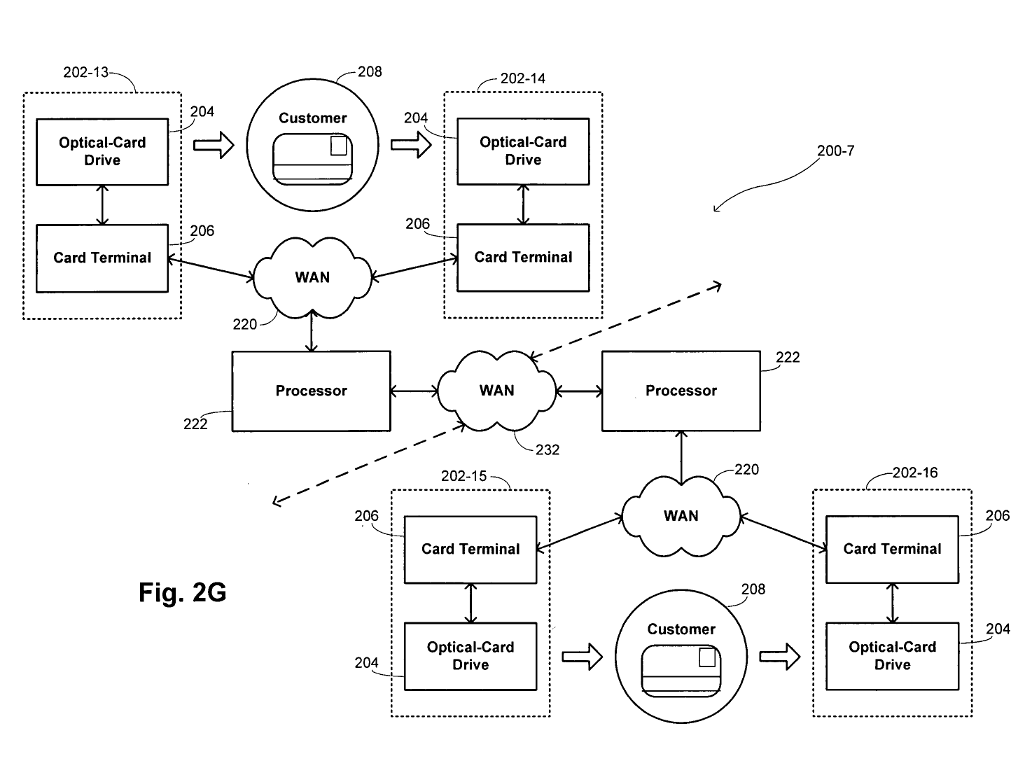

One network structure 200-1 that may be used to perform banking transactions with the optical banking cards is illustrated in FIG. 2A. In this figure, each TPU 202 is shown to comprise an optical-card drive 204 and a card terminal 206. These components may be provided as separate components of the TPU or may be integrated in different embodiments. The optical-card drive 204 is configured for reading from and writing to optical cards, while the card terminal comprises a computational device used in authorizing and executing specific transactions. While the drawing in FIG. 2A shows two TPUs 202 for illustrative purposes, there will generally be a much larger number of TPUs distributed geographically so that a customer 208 may access banking-transaction services at any of multiple TPUs. Each time the customer 208 executes a transaction at a TPU 202, information about the transaction and updates to a financial status associated with the optical banking card may be written to the card. This information is then accessible by a subsequent TPU 202 to which the card is presented in initiating a later transaction.

In some instances, as shown by the network structure 200-2 of FIG. 2B, a transaction station may include a variety of additional devices used in executing certain types of transactions. In addition to the optical-card drive and terminal, a number of other operational components 210 may be included, as shown for transaction station 202-4. For example, an automated cash receiver may be provided to accept cash currency from the customer 208, used as described below in such transactions as making deposits that are recorded on the optical card. An automated cash dispenser may be used to provide cash to the customer 208 in performing such transactions as making withdrawals, cashing checks or other negotiable instruments, and the like. A magnetic-stripe reader may be used to read identifying information from a card or other instrument that has a magnetic stripe, like a credit card. A magnetic-ink character-recognition (“MICR”) reader may be provided to read information printed in magnetic ink, such as from a check, money order, or other negotiable instrument. A smart-card reader may be provided to read identifying information from a device that has a readable chip. These additional operational components are identified merely as examples of the types of additional components that may be provided at a transaction station and the list is not intended to be exhaustive; still other types of components may be provided in other embodiments. Each of these components will generally be provided in communication with the card terminal 206 to allow coordination of functions with operation of the optical-card drive.

The network structure 200-2 shown in FIG. 2B operates in a fashion similar to that of FIG. 2A, except that some transaction stations may include the enhanced functionality provided by the additional operational components. Other transaction stations, such as TPU 202-3 may still have the more limited functionality of the units of FIG. 2A, or may have only some of the additional operational components, reflecting the fact that different banking-transaction services may be available at different geographical locations.

In other embodiments, the network structure may permit additional communications between TPUs 202 to occur by electronic or other mechanisms different from the distribution of the optical banking cards themselves. Such a network structure 200-3 is illustrated in FIG. 2C, in which each TPU 202 has its card terminal 206 in communication with a processor 212. The processors 212 may communicate through a non-optical network, such as a wide-area network 214. Each processor 212 may additionally be coupled with one or more databases that maintain information related to accounts associated with the optical cards, policies governing transactions, and the like.

The network structure 200-3 of FIG. 2C may be used to provide enhanced transaction services that rely on additional communications between financial institutions, some of which are described further below. For example, in one embodiment, each of a plurality of TPUs 202 associated with a first financial institution may be in communication with a first processor 212 and each of a plurality of TPUs 202 associated with a second financial institution may be in communication with a second processor 212. For example, such a structure may be useful where there exist multiple networks of TPUs, each associated with a different financial institution. In some such cases, communication within each of the TPU networks may be made solely with optical banking cards, with the WAN 214 permitting interaction between the otherwise distinct networks. In other cases, the processors 212 may be used to interconnect subnetworks within a single network of TPUs associated with a single financial institution. In still other cases, every TPU within a network associated with a single financial institution may be in communication with a different processor 212, the WAN 214 thereby providing an alternative mechanism for interconnecting the network that does not rely on the distribution of optical cards. Such interconnection may be useful in providing certain banking-transaction services, particularly when execution of those services advantageously interacts with a traditional financial-services architecture that does not use optical cards.

Similar networking capabilities may be used to provide an interconnection of other types of transaction stations with the network of optical-card TPUs, as illustrated schematically in FIG. 2D. The network architecture 200-4 in this drawing is similar to the architecture shown in FIG. 2C, with the addition of another wide-area network 216 that interconnects one of the processors 212 with one or more transaction stations 218. These transaction stations 218 may have one or more operational components, like a cash dispenser, cash receiver, magnetic-stripe reader, MICR reader, smart-card reader, and the like, allowing banking transactions to be executed that make use of such components. For instance, in an embodiment where such a transaction station 218 is a traditional automatic teller machine (“ATM”) having a cash dispenser, cash receiver, and magnetic-stripe reader, banking transactions may be executed within the network without an optical banking card. Such an arrangement thus provides an arrangement where a financial institution's network comprises transaction stations that include different types of operational components, some of which include optical-card TPUs and others that do not, thereby making different types of services available at different locations. Similar to the embodiment of FIG. 2C, such a network may communicate with a distinct network of another financial institution through wide-are network 214.

FIG. 2E provides an example of a network architecture 200-5 in which multiple optical-card TPUs 202 are capable of communication with a single processor 222 through a wide-area network 220. Such a configuration may be appropriate for a network associated with a single financial institution so that operations of the TPUs 202 may be handled consistently be the single processor.

Like the embodiment of FIG. 2D, which extends the embodiment of FIG. 2C to accommodate other transaction stations, the embodiment of FIG. 2E may also be extended to accommodate other transaction stations as shown in FIG. 2F. In this embodiment, the network architecture 200-6 includes a wide-area network 226 that allows communications between optical-card TPUs 202 and a single processor 228. To emphasize that the optical-card TPUs may include additional operational components 210 in any embodiment, such additional components are shown explicitly for TPU 202-12. More generally, some of the optical-card TPUs 202 may comprise one or more such additional components while other optical-card TPUs 202 may comprise only the optical-card drive 204 and card terminal 206. Other transaction stations 218 that may comprise any components suitable for executing banking transactions, including or not including optical-card-based transactions may be provided in communication with the processor through another wide-area network 230.

In still other embodiments, the arrangement shown in FIG. 2E may be extended to allow interfacing multiple optical-card subnetworks that are otherwise distinct. In FIG. 2G, the network architecture 200-7 comprises multiple subnetworks that each correspond to the network 200-5 of FIG. 2E, including TPUs 202 in communication with a single processor 222 through a wide-area network 220. These subnetworks are themselves interconnected through a wide-area network 232 that allows communications to take place between the processors 222 associated with each of the subnetworks. While the architecture 200-7 is shown explicitly for two such subnetworks, the architecture 200-7 may more generally comprise any number of such subnetworks linked through the wide-area network, as indicated schematically with the dashed connection lines.

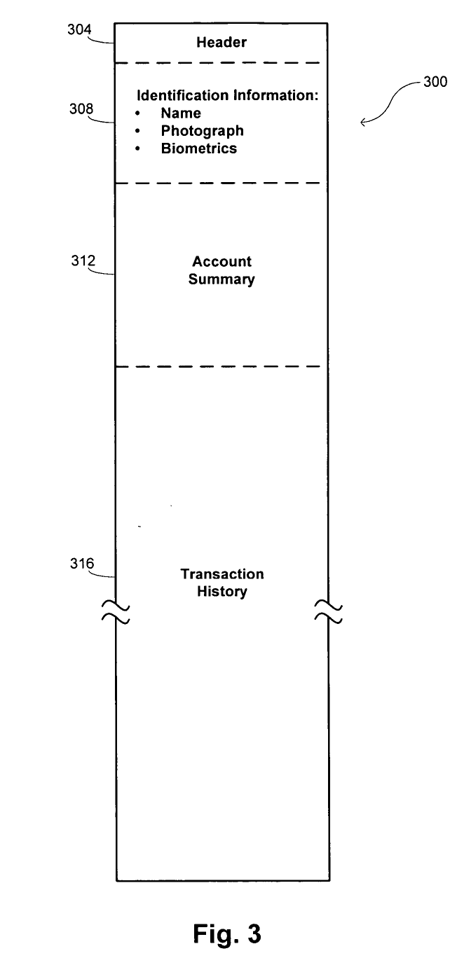

The optical banking cards used by any of the architectures described in connection with FIGS. 2A-2G may use any of a variety of different data structures to store information used in executing and/or maintaining a record of banking transactions. One such data structure 300 is shown explicitly in FIG. 3 for illustrative purposes. In this embodiment the optical-banking-card data structure 300 comprises a header 304, fields 308 for identification information, fields 312 for summarizing a status of an account associated with the optical banking card, and fields 316 for maintaining a transaction history of some or all transactions in which the optical banking card is involved. The header 304 identifies the data structure 300 and includes a description of the data structure, specifying such characteristics as size, encryption format, certificate format, version information, and the like. The identification fields 308 include optically encoded representations of such identification information as a name of the cardholder, a photograph of the cardholder, and biometrics unique to the cardholder, such as fingerprints, retinal scans, hand-geometry specifications, and the like. The optically encoded photograph is rendered in digital form, as opposed to a visual rendering such as might be done in ink. This identification information may be used when transactions are performed to verify that the individual attempting to use the optical banking card for transactions is indeed the person who has been authorized to do so.

The account-summary field 312 generally contains an overview of the account status. For example, this field 312 may include a current balance for the account, as well as a variety of codes to indicate that the account is active or inactive, that the account is overdrawn or not, and the like. The transaction-history field 316 generally includes a complete record of transactions in which the card was used. It may specify, for each such transaction, such information as the nature of the transaction (deposit, withdrawal, transfer, bill payment, etc.), the size of the transaction, the identities of parties to the transaction, the balance of the account after execution of the transaction, and the like. In this way, the data structure 300 may include a complete history suitable for performing audits of the account if necessary, such as for forensic use, to deter fraud, and/or to enable reconstruction of transactions to resolve disputes. In many embodiments, the information in the identification fields 308, account-summary fields 312, and transaction-history fields 316 is encrypted according to a format identified in the header 304 to provide enhanced security of the information.

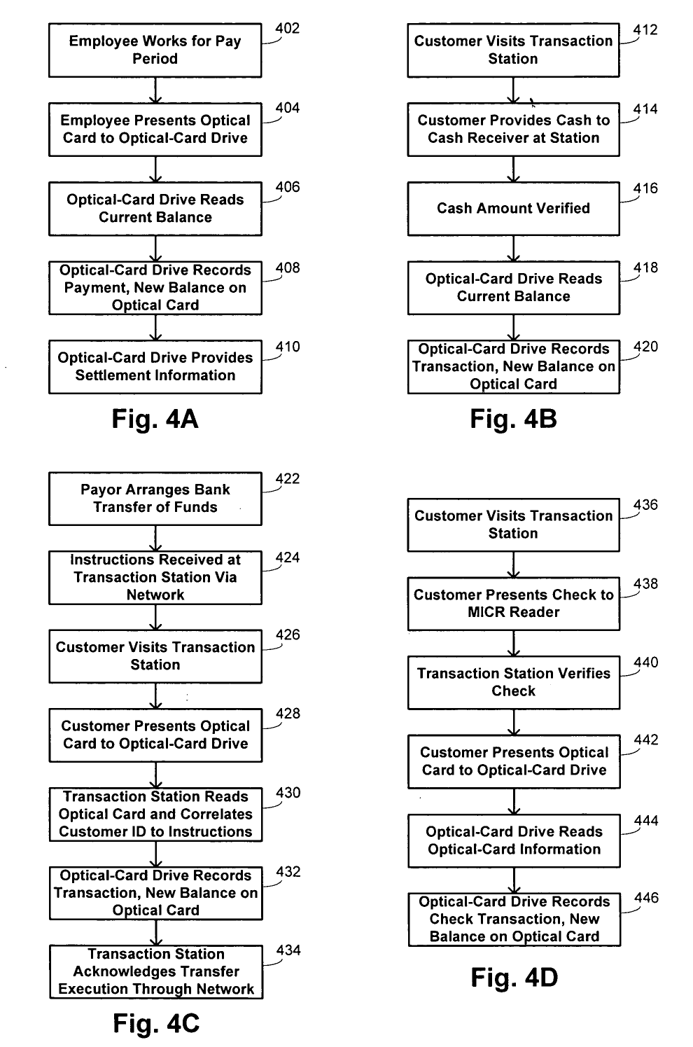

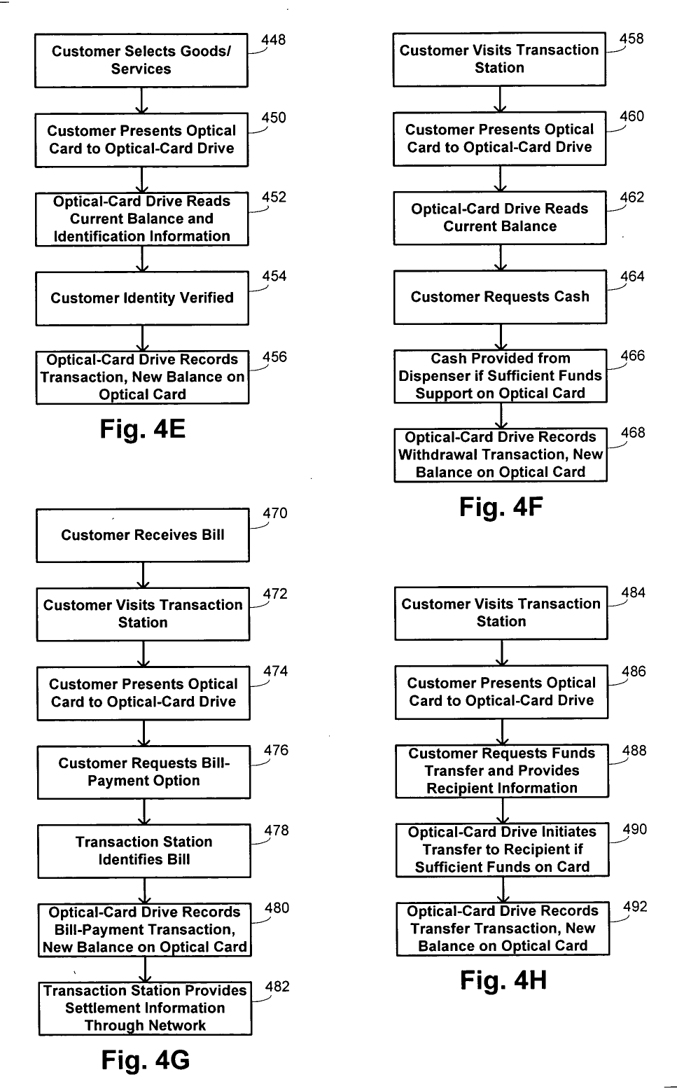

We now turn to an illustration of how various types of banking transactions may be executed using the optical banking cards within the architectures of FIGS. 2A-2G and with the exemplary data structure shown in FIG. 3. These illustrations are shown with flow diagrams in FIGS. 4A-4H and are not intended to be exhaustive. Methods for executing a variety of other banking transactions using optical banking cards will be evident to those of skill in the art after considering these illustrations. FIGS. 4A-4D generally provide examples of transaction where the holder of the optical banking card receives funds that are recorded on the optical banking card by augmenting the account balance, while FIGS. 4E-4H provide illustrations of transactions where the holder pays for a transaction with funds recorded on the optical banking card by reducing the account balance.

FIG. 4A illustrates a transaction in which the holder of the optical banking card is a employee whose wages are paid by adding value to the account associated with the optical banking card, thereby providing payroll-distribution transactions. After the employee works for a period of time, as indicated at block 402, the employee presents the optical banking card to an optical-card drive at block 404 to receive payment of wages. The optical-card drive reads the current balance of the account associated with the card at block 406, usually from the account-summary field 312 that identifies a current balance for the account. This balance is augmented by the amount of the wages so that, at block 408, the optical-card drive records details of the payment of wages in the transaction-history field 316 and records an updated current balance in the account-summary field 312. The entry in the transaction-history field 316 may include such details as an identification of the employer payor of the wages, the date of the transaction, the amount of the wages, and the like. In some instances, the optical-card drive may further initiate settlement of the transaction so that an account of the employer payor is properly debited by providing settlement information at block 410. Such settlement information may be transmitted across a wide-area network to an appropriate settlement authority using one of the architectures having such connectibility previously discussed. Transactions collected at remote areas may generally be transmitted to a central settlement house either by online methods if sufficiently inexpensive telecommunications exists, or even by courier optical card that contains all such transactions if such telecommunications does not exist.

FIG. 4B illustrates a deposit transaction in which the card holder deposits cash that is credited to the account associated with the optical banking card. At block 412, the cardholder visits a transaction station like the TPUs discussed above in connection with FIGS. 2A-2G. The transaction station in these embodiments includes a cash receiver so that the customer may provide the cash to the cash receiver at block 414. The amount of cash provided is verified by the transaction station at block 416 using currency-recognition software comprised by the cash receiver. The current balance of the account associated with the optical banking card is read from the optical banking card at block 418. This balance is updated by the optical-card drive at block 420 by recording a new balance augmented by the verified cash amount in the account-summary field 312. In addition, a record of the transaction is generally recorded in the transaction-history filed 316, identifying the transaction as a cash deposit, and specifying such details as the date, the amount of the cash deposit, the transaction station at which the deposit was made, and the like.

The network architectures that provide for integration with traditional online nonoptical banking networks may be used to effect transfers of funds to optical cards, such as is illustrated with the flow diagram of FIG. 4C. In this embodiment, a payor arranges for a bank transfer of funds at block 422, such as by visiting a traditional bank that is connected to a traditional banking network. For example, in the network architectures 200-4 or 200-6 illustrated in FIG. 2D, the payor might visit a transaction station 218 to arrange for the transfer. The transaction station 218 could comprise a manned station, such as at a teller station in a bank, or could comprise an unmanned station, such as for an ATM. Communications are issued to the optical-card network, such as by communicating through WAN 216 or WAN 230, depending on whether the optical-card network uses a single processor 228 as in FIG. 2F or uses multiple processors as illustrated in FIG. 2D. In the case where a single processor is used as in FIG. 2F, communications to a particular transaction station 202 may be made at block 424 by routing through WAN 226, while the communications might be made directly from a corresponding processor 212 in those instances where each transaction station 202 has an associated processor 212 as in FIG. 2D.

Irrespective of how the communications are coordinated to provide instructions of the transfer to a particular transaction station, that transaction station is prepared to effect the transfer upon receipt of the instructions. Accordingly, at block 426 the recipient customer visits the transaction station and presents his optical card to the optical-card drive at block 428. The transaction station reads the optical card at block 430 to identify the customer recipient and correlates that identification with a recipient identity specified by the received transfer instructions. The transfer is effected by crediting the optical card with the specified fund amounts at block 432. This may be done by updating the account-summary field 312 with a new balance augmented by the transfer amount and by recording detailed transaction information in the transaction history field 316. In this instance, the detailed transaction information typically includes a date of the transfer, the amount of the transfer, an identification of the payor, and the like. The collection of the transferred funds may be acknowledged back to the payor by sending communications from the transaction station back through the network architecture at block 434. Thus, an electronic confirmation may be provided, with “electronic” being intended to describe a confirmation made online or by optical card.

A further example of a banking transaction that results in a credit to the customer is illustrated in FIG. 4D in the form of cashing a negotiated instrument such as a check. This transaction is similar in some ways to the deposit transaction discussed in connection with FIG. 4B, except that a value of the check is verified instead of verifying a cash amount. Accordingly, at block 436, the customer visits an optical-card transaction station and presents a check to a MICR reader at block 438. The transaction station may verify the authenticity of the check at block 440, such as by verifying the validity of routing and account numbers printed on the check in magnetic ink, verifying check characters, checking the amount printed on the check, ensuring the check is endorsed, and the like. To have the value of the check credited to the optical card, the customer presents the optical card to the optical-card drive at block 442. The optical-card drive reads information from the optical card at block 444, enabling an identity of the customer to be verified through a comparison of biometrics or other identification information read from the identification field 308. The value of the check is added by the optical-card drive at block 446 by writing updating summary information in the account-summary field 312 and writing a detailed record of the transaction in the transaction-history field 316. For this type of transaction, such a detailed record may identify that a check was cashed, the routing and account numbers printed on the check, the amount of the transaction, the date, and the like. Recovery of the check amount may proceed in a traditional fashion by further negotiating the check through a clearinghouse to recover the credited funds from the account identified on the check.

In some cases, the customer may request that the value of the check be delivered in cash rather than simply being credited to the optical card. Such requests may be accommodated at transaction stations that include a cash dispenser, but will usually require that a hold be placed on funds to mitigate against a potential failure to recover funds from the identified account. This may be done by distinguishing on the optical banking card between cleared and held funds, such as by identifying separate balances with appropriate indicia. Effectively, the cash that is received by the customer is drawn from cleared funds on the optical banking card, with the value of the check being added to funds that are held for a certain time period. If the customer visits an optical-card transaction station after the time period, as deduced from a date record that accompanies the hold, the status of the funds may be changed to cleared. Thus, receipt of cash for a check or other negotiable instrument will generally be limited to a value that previously existed on the optical banking card in the form of cleared funds. Exceptions to such holds may be implemented for certain check issuers when it is known that the possibility of default is very remote. Mechanisms may also be used in clearing funds in embodiments that integrate online and optical-card systems, such as where the optical cards comprise magnetic stripes used in providing compatability with older legacy online banking networks. In embodiments that use such compatability, an arbitrary hold period, such as a 24-hour hold period, may be imposed on offline deposits made in remote areas where telecommunications is limited or expensive.

The use of the optical banking card as a source of funds is also extremely diverse, and the examples of such applications in FIGS. 4E-4H merely give an broad indication of how they may be used in this way. For example, FIG. 4E illustrates the use of an optical banking card as a source of funds for the purchase of goods and/or services, thereby acting as a substitute for a check, debit card, stored-value card, and other such instruments to provide a debit purchase transaction. To effect a purchase, the customer selects the goods and/or services to be purchased at block 448 and presents his optical banking card to an optical-card drive at block 450. Such an optical-card drive may be present at merchant or any other locations that participate in the optical-card banking system. The optical-card drive reads identification information from the identification field 308 and a current balance from the account-summary fields at block 452. Greater care to ensure the identity of the person presenting the card with the encoded identification information may be made in instances where value is being taken from the optical banking card than in cases where value is being added to the card. The identity of the customer is accordingly verified at block 454, such as by comparing the encoded photograph with the customer's face, measuring certain biometrics from the customer at the point of presentment for comparison with the encoded biometrics, and the like. If the customer's identity is confirmed and there is a sufficient balance on the optical banking card to support the purchase, the purchase is executed and a record of it is included on the card at block 456. As for other transactions, such a record typically includes updated account-summary information written to the account-summary field 312 and a record of the transaction written to the transaction-history field 316. Such a transaction-history record may identify the date, the amount of the purchase, the purchase location, and even identify the specific goods and/or services that were purchased in some embodiments.

Another example of a transaction where value is taken from the optical banking card is illustrated in FIG. 4F in the form of a withdrawal. The withdrawal may be effected by the customer visiting the transaction station at block 458 and presenting his optical card to the optical-card drive at block 460. The optical-card drive reads information from the optical card at block 462, generally including identification information so that the identity of the customer may be verified and current-balance information to ensure that the size of the withdrawal request may be supported. In instances where some funds may be earmarked as cleared while others are held, ensuring that the withdrawal request may be supported may comprise ensuring that the withdrawal request may be supported from cleared funds. The customer may request the withdrawal in the form of cash, as indicated at block 464, so that cash is provided from a cash dispenser comprised by the transaction station at block 466. In other embodiments, the withdrawal may be requested in other forms, such as in the form of a certified check, money order, or other form of certified funds. In such embodiments, distribution of the amount may be made by printing an instrument with a suitable operational component such as a printer and magnetic-ink writer. Regardless of the form of the withdrawal, the optical-card drive again records the transaction on the optical card by updating information in the account-summary and transaction-history fields 312 and 316. The transaction record written to the transaction-history field 316 may include such details as the date of the withdrawal, the form of its distribution, the amount of the withdrawal, the location of the withdrawal, and the like.

The optical banking card may also be used for bill-payment services as indicated with the flow diagram of FIG. 4G. In this embodiment, a customer receives a bill at block 470, such as a utilities, rent, or other type of bill. To pay the bill, rather than write a check, the customer may visit an optical-card transaction station at block 472 and present the optical banking card to the optical-card drive at block 474. The customer indicates a desire to pay a bill at block 476 and the transaction station identifies the bill at block 478. Such identification may be made in a variety of different ways, including having the customer key in account number information, reading such information directly from the bill with an optical-character-recognition system, reading MICR encoding of the information from the bill, and the like. In addition, the optical-card drive reads identification and account-summary information from the optical card to allow the identity of the customer to be verified and to ensure that sufficient (cleared) funds are available to support the bill amount; these functions have been previously described and are not reproduced in FIG. 4G. Once the transaction station has identified the bill to be paid, including the recipient, and has confirmed that there are sufficient funds available on the optical banking card to make payment, the transaction is executed. Such execution takes two forms. First, the value on the optical banking card is reduced by the payment amount at block 480 by recording updated account-summary information and a detailed record of the transaction. For this type of transaction, such a detailed record may specify the recipient of the payment, the date of the payment, the amount of the payment, the type of payment (rent, utilities, etc.), and the like. Second, settlement information is provided to the issuer of the bill, or its financial institution, at block 482 so that the amount debited from the optical banking card may be credited to the issuer.

FIG. 4H illustrates the reciprocal transaction of that discussed in connection with FIG. 4C-rather than a cardholder being the recipient of a funds transfer from a third party, FIG. 4H illustrates a transaction in which the cardholder initiates a transfer of funds to a third party. This is done by visiting the transaction station at block 484, where the customer presents his optical card to the optical-card drive at block 486. The customer indicates his wish to execute a funds transfer and specifies the amount to be transferred and the recipient, usually by identifying an account number where the transferred funds are to be deposited. Similar to the other embodiments discussed above, the optical-card drive reads identification and account-summary information so that the identity of the cardholder may be verified and to ensure that sufficient (cleared) funds are available to support the size of the transfer. If so, the optical-card drive communicates information directing the deposit of funds in the identified account at block 490, such as by providing communications over a network as illustrated with the various network architectures in FIGS. 2A-2G. At block 492, the optical-card drive records the transaction by writing updated account-summary information to the card and by writing a detailed record of the transaction. Such a detailed record for this type of transaction may include an identification of the recipient of the transfer, the value of the funds transferred, the date of the transfer, and the like.

Having described several embodiments, it will be recognized by those of skill in the art that various modifications, alternative constructions, and equivalents may be used without departing from the spirit of the invention. For example, while a number of specific types of banking transactions have been illustrated in detail, other types of banking transactions may also be performed, such as offline lending transactions, and the like. Accordingly, the above description should not be taken as limiting the scope of the invention, which is defined in the following claims.

1. A method for executing a banking transaction for a customer, the method comprising:
reading account information from an optical banking card for a banking account associated with the optical banking card, the account information including a current balance for the banking account;
receiving a request from the customer to execute the banking transaction, wherein the banking transaction effects a change in the balance of the account;
coordinating a movement of funds in accordance with the request to execute the banking transaction; and
writing updated account information to the optical banking card, the updated account information including a new current balance for the banking account that accounts for the movement of funds.

2. The method recited in claim 1 wherein coordinating the movement of funds comprises receiving funds for allocation to the banking account by augmenting the current balance.

3. The method recited in claim 2 wherein:
receiving funds comprises receiving cash from the customer; and
the new current balance is equal to the current balance plus a value of the cash,
whereby the banking transaction corresponds to a deposit to the banking account.

4. The method recited in claim 2 wherein:
receiving funds comprises receiving an electronic confirmation that funds have been provided by a third party; and
the new current balance is equal to the current balance plus a value of the funds provided by the third party,
whereby the banking transaction corresponds to a funds transfer from the third party to the banking account.

5. The method recited in claim 2 wherein:
receiving funds comprises receiving electronic confirmation of funds provided by an employer of the customer as wages; and
the new current balance is equal to the current balance plus a value of the wages,
whereby the banking transaction corresponds to a payroll distribution from the employer to the customer.

6. The method recited in claim 2 wherein:
receiving funds comprises receiving a negotiated instrument from the customer; and
the new current balance is equal to the current balance plus a value of the negotiated instrument,
whereby the banking transaction corresponds to cashing the negotiated instrument.

7. The method recited in claim 6 wherein writing updated account information to the optical banking card comprises designating a portion of the new current balance corresponding to the value of the negotiated instrument as held funds.

8. The method recited in claim 1 wherein a first portion of the current balance is designated as cleared funds and a second portion of the current balance is designated as held funds.

9. The method recited in claim 1 wherein coordinating the movement of funds comprises providing funds allocated from the banking account by reducing the current balance.

10. The method recited in claim 9 wherein:
providing funds comprises providing cash to the customer; and
the new current balance is equal to the current balance less a value of the cash,
whereby the banking transaction corresponds to a withdrawal from the banking account.

11. The method recited in claim 9 wherein:
providing funds comprises providing funds electronically to a merchant entity for goods or services purchased by the customer; and
the new current balance is equal to the current balance less a payment value for the goods or services,
whereby the banking transaction corresponds to a debit purchase transaction.

12. The method recited in claim 9 further comprising obtaining information defining a payment amount and issuer of a bill to the customer, wherein:
providing funds comprises providing funds equal to the payment amount electronically to the issuer; and
the new current balance is equal to the current balance less the payment amount,
whereby the banking transaction corresponds to a bill-payment transaction.

13. The method recited in claim 9 wherein:
providing funds comprises providing funds electronically to a third party; and
the new current balance is equal to the current balance less a value of the funds provided to the third party,
whereby the banking transaction corresponds to a funds transfer from the banking account to the third party.

14. The method recited in claim 1 further comprising:
reading identification information of an authorized holder of the optical banking card from the optical banking card; and
verifying that the customer is the authorized holder from the identification information.

15. The method recited in claim 14 wherein the identification information comprises an optically encoded photograph of the authorized holder.

16. The method recited in claim 14 wherein the identification information comprises an optically encoded record of a biometric feature of the authorized holder.

17. The method recited in claim 14 further comprising reading a designation from the optical banking card that a biometric identification requirement has been overridden so that verifying that the customer is the authorized holder is performed without a biometric comparison.

18. The method recited in claim 1 wherein the updated account information further includes a specification of particulars of the executed banking transaction.

19. A method for executing a banking transaction for a customer, the method comprising:
reading identification information of an authorized holder of an optical banking card from the optical banking card;
comparing the identification information with a feature of the customer to verify that the customer is the authorized holder;
reading account information from the optical banking card for a banking account associated with the optical banking card, the account information including a current balance for the banking account;
receiving a request from the customer to execute the banking transaction,
wherein the banking transaction effects a change in the balance of the account;
coordinating a movement of funds in accordance with the request to execute the banking transaction; and
writing updated account information to the optical banking card, the updated account information including a new current balance for the banking account that accounts for the movement of funds and including a specification of particulars of the executed banking transaction.

20. The method recited in claim 19 wherein coordinating the movement of funds comprises receiving funds for allocation to the banking account by augmenting the current balance and the banking transaction corresponds to a transaction selected from the group consisting of a deposit to the banking account, a funds transfer from a third party to the banking account, a payroll distribution from an employer to the customer, and cashing of a negotiated instrument.

21. The method recited in claim 19 wherein coordinating the movement of funds comprises providing funds allocated from the banking account by reducing the current balance and the banking transaction corresponds to a transaction selected from the group consisting of a withdrawal from the banking account, a debit purchase transaction, a bill-payment transaction, and a funds transfer from the banking account to a third party.

22. An optical banking card comprising a laminated card having a pattern of burn holes that encode information according to a set of fields, the set of fields including:
an identification field having optically encoded information identifying a feature of an authorized holder of the optical banking card;
an account-summary field having optically encoded information summarizing a status of a banking account associated with the optical banking card; and
a transaction-history field having optically encoded information providing particulars of a plurality of banking transactions executed with the optical banking card.

23. The optical banking card recited in claim 22 wherein the transaction-history field provides particulars for every banking transaction executed with the optical banking card.

24. The optical banking card recited in claim 22 wherein the information identifying the feature of the authorized holder comprises biometric information.
